(19) United States
(12) Patent Application Publication
(10) Pub. No.: US 2026/0141303 A1
(43) Pub. Date: May 21, 2026

(54) NON-TRANSITORY COMPUTER-READABLE RECORDING MEDIUM, MACHINE TRAINING DEVICE, AND MACHINE TRAINING METHOD

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/387,745

(22) Filed: Nov. 13, 2025

(30) Foreign Application Priority Data
Nov. 20, 2024 (JP) 2024-202706

(51) Int. Cl. G06N 20/00

(52) U.S. Cl. CPC G06N 20/00

(57) ABSTRACT

A non-transitory computer-readable recording medium stores therein a program that causes a computer to execute a process including acquiring a multi-objective optimization problem including a plurality of cost functions, extracting a plurality of weight parameters based on a simplex constructed by points corresponding to a number of the weight parameters that weight the respective cost functions, and training a machine training model that outputs a second solution set corresponding to a predetermined weight parameter by inputting a mapping to a first solution set corresponding to the weight parameters.

### CROSS-REFERENCE TO RELATED APPLICATION

This application is based upon and claims the benefit of priority of the prior Japanese Patent Application No. 2024-202706, filed on Nov. 20, 2024, the entire contents of which are incorporated herein by reference.

### FIELD

The embodiments discussed herein are related to a computer-readable recording medium, a machine training device, and a machine training method.

### BACKGROUND

A constrained combinatorial optimization problem is the most important problem in combinatorial optimization, and has many practical applications. In recent years, along with development of information science, a technique aiming at high-speed solution of combinatorial optimization by machine training has been developed. The related technologies are described, for example, in: Japanese Laid-open Patent Publication No. 2023-059128, Japanese Laid-open Patent Publication No. 2022-188527, U.S. Patent Application Publication No. 2022/0215137, and U.S. Patent Application Publication No. 2022/0012542.

### SUMMARY

According to an aspect of an embodiment, a non-transitory computer-readable recording medium stores therein a program that causes a computer to execute a process including acquiring a multi-objective optimization problem including a plurality of cost functions, extracting a plurality of weight parameters based on a simplex constructed by points corresponding to a number of the weight parameters that weight the respective cost functions, and training a machine training model that outputs a second solution set corresponding to a predetermined weight parameter by inputting a mapping to a first solution set corresponding to the weight parameters.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the entire processing of a machine training device according to an embodiment;

FIG. 2 is a diagram illustrating an example of processing at the time of training of the machine training device according to the embodiment;

FIG. 3 is a diagram illustrating an example of processing at the time of using the machine training device according to the embodiment;

FIG. 4 is a block diagram of the machine training device according to the embodiment;

FIG. 5 is a diagram illustrating an example of a cost function storage unit of the machine training device according to the embodiment;

FIG. 6 is a diagram illustrating an example of a weight parameter storage unit of the machine training device according to the embodiment;

FIG. 7 is a diagram illustrating an example of a Pareto optimum solution storage unit of the machine training device according to the embodiment;

FIG. 8 is a diagram illustrating an example of a machine training model storage unit of the machine training device according to the embodiment;

FIG. 9 is a flowchart of the entire processing performed by the machine training device according to the embodiment;

FIG. 10 is a flowchart of model training processing performed by the machine training device according to the embodiment;

FIG. 11 is a flowchart of model use processing performed by the machine training device according to the embodiment; and

FIG. 12 is a hardware configuration diagram of the machine training device.

### DESCRIPTION OF EMBODIMENTS

However, in the technique described above, it is difficult to solve a multi-objective optimization problem for simultaneously optimizing a plurality of cost functions and to rapidly generate a Pareto optimum solution as a solution set. In the above-described technique, a solver needs to be executed for each weight parameter that weights the cost function, and it may take time to generate a Pareto optimum solution.

Preferred embodiments will be explained with reference to accompanying drawings. The invention is not limited to the embodiment. Embodiments can be appropriately combined with each other within a range without inconsistency.

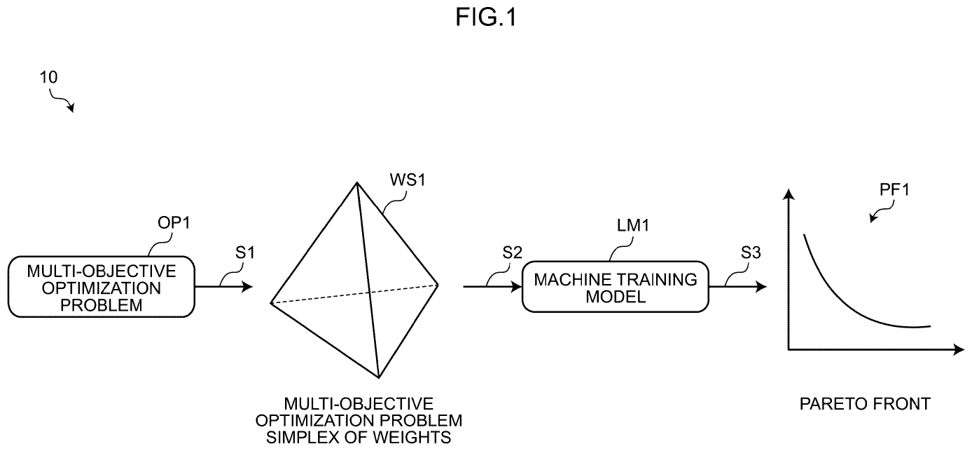

Explanation of machine training device 10 FIG. 1 is a diagram illustrating an example of the entire processing of a machine training device 10 according to the embodiment. The machine training device 10 illustrated in FIG. 1 is an example of a computer device that trains a multi-objective optimization problem OP1, and generates a Pareto front PF1 as a solution set PS1 of the multi-objective optimization problem OP1.

As illustrated in FIG. 1, the machine training device 10 extracts a weight parameter WP1 of the multi-objective optimization problem OP1 from a multidimensional simplex WS1 (Step S1). For example, the machine training device 10 acquires, from a user U1, an M-objective optimization problem in which M cost functions are simultaneously optimized by the multi-objective optimization problem OP1, and extracts P weight parameters WP1 from an (M−1)-dimensional simplex WS1 constructed by M weight parameters WP1.

The machine training device 10 trains a machine training model LM1 using a mapping to the solution set PS1 corresponding to the extracted P weight parameters WP1 (Step S2). For example, the machine training device 10 formulates a slack variable as a response function that is a function of the weight parameter WP1, converts the P weight parameters WP1 into embedding vectors, and minimizes an empirical loss related to the P weight parameters WP1. Additionally, after performing linear scaling on the P weight parameters WP1 and a bias b1 corresponding to the weight parameters WP1, the machine training device 10 similarly minimizes the empirical loss related to the P weight parameters WP1.

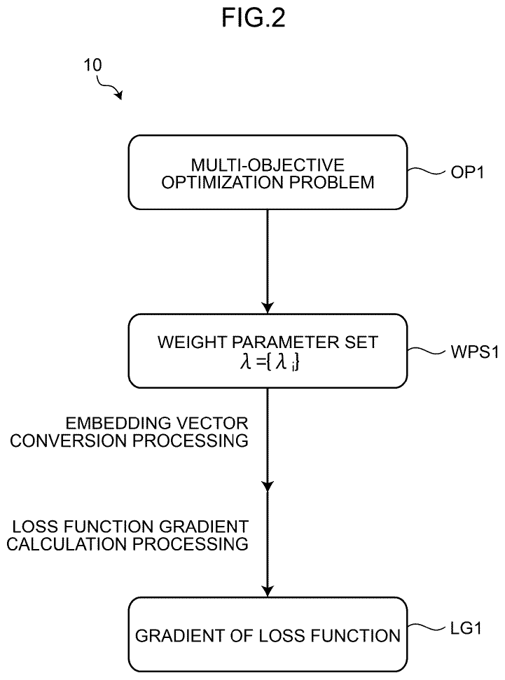

FIG. 2 is a diagram illustrating an example of processing at the time of training of the machine training device 10 according to the embodiment. As illustrated in FIG. 2, the machine training device 10 extracts λ={λᵢ} as a weight parameter set WPS1 by extracting the weight parameters WP1 of the multi-objective optimization problem OP1 from the simplex WS1. The machine training device 10 performs node embedding or linear embedding by embedding vector conversion processing, and calculates a gradient LG1 of a loss function indicating an empirical loss by loss function gradient calculation processing. The machine training device 10 trains the machine training model LM1 as described above.

The machine training device 10 generates the Pareto front PF1 as the solution set PS1 corresponding to an unknown weight parameter WP1* (Step S3). For example, by inputting the unknown weight parameter WP1* to the trained machine training model LM1, the machine training device 10 generates the Pareto front PF1 indicating a Pareto optimum solution corresponding to the unknown weight parameter WP1*, and transmits the Pareto front PF1 to the user U1.

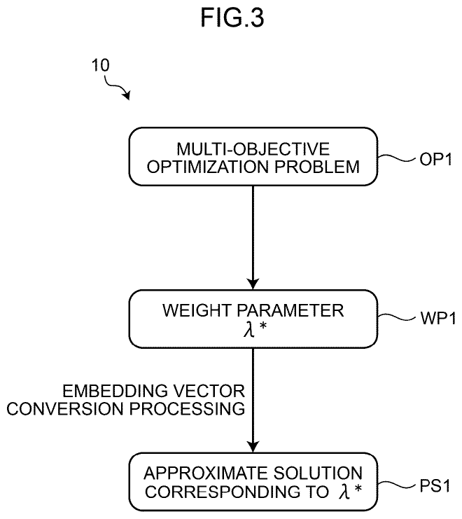

FIG. 3 is a diagram illustrating an example of processing at the time of using the machine training device 10 according to the embodiment. As illustrated in FIG. 3, the machine training device 10 extracts λ* as the unknown weight parameter WP1* of the multi-objective optimization problem OP1. The machine training device 10 also performs node embedding or linear embedding by embedding vector conversion processing, and generates the solution set PS1 as an approximate solution corresponding to λ*, which is the unknown weight parameter WP1*. The machine training device 10 uses the machine training model LM1 as described above.

Optimization method A constrained combinatorial optimization problem is the most important problem in combinatorial optimization, and has many practical applications. For example, a general-purpose solver including an Ising machine searches for a constraint-satisfying solution by a penalty method. However, solving is difficult in some cases depending on a penalty coefficient. In a local transition algorithm such as an Ising machine, only local solutions can be searched for, so that it is difficult to acquire diverse solutions at once. In recent years, along with development of information science, a technique aiming at high-speed solution of combinatorial optimization by machine training has been developed.

The multi-objective optimization problem aims at simultaneously optimizing M cost functions f₁(x), f₂(x), . . . , f_{M}(x) with respect to arbitrary x∈X. In a typical multi-objective optimization problem, there is no “minimizer x” that minimizes all cost functions.

As a countermeasure to the above, a solution set in which a certain cost function is not able to be improved without deteriorating any other cost function, that is, a Pareto optimum solution defined by the following expression (1), are acquired, and a preferred solution is acquired.

$$x = \{ x \text{?} x ∈ X , s . \text{?} Vi ∈ [ M ] , f \text{?} ( x ) \leq {f}_{i} ( x \text{?} ) , ∃ j ∈ [ M ] , \text{?} ( x ) < {f}_{j} ( x \text{?} ) \} \qquad ( 1 )$$

$$\text{?} \text{indicates text missing or illegible when filed}$$

In addition, as a relaxation problem, acquisition of the Pareto optimum solution is obtained as a relaxed single-objective optimization problem represented by the following expression (2) in some cases.

$${min}_{x ∈ X} {\sum }_{i = 1}^{M} {λ}_{i} {f}_{i} ( x ) , ∀ i ∈ [ M ] , {λ}_{i} ∈ {ℝ}_{+} , s . t . {\sum }_{i = 1}^{M} {λ}_{i} = 1 \qquad ( 2 )$$

At this time, in a case where fi(x) is a convex function and X is a convex set for arbitrary i∈[M], it is guaranteed that the Pareto optimum solution can be acquired by solving at least an arbitrary relaxed single-objective optimization problem represented by the following expression (3).

$$\{ λ = {( {λ}_{i} )}_{i = 1}^{M} \vert {\sum }_{i = 1}^{M} {λ}_{i} = 1 \} \qquad ( 3 )$$

### Continuous Relaxation Method

A continuous relaxation method is an optimization method that solves a problem by relaxing discrete optimization represented by the following expression (4) to continuous optimization represented by the following expression (5) with respect to a parameter C characterizing the problem. Herein, the parameter C is an instance parameter IP1. For example, in a case of a knapsack problem, the parameter C is a parameter set corresponding to prices of sweets or a capacity of a knapsack.

$$E ( \cdot ; C , γ ) : {\{ 0 , 1 \}}^{N} \times ℝ \qquad ( 4 )$$

$$\hat{E} ( \cdot ; C , γ ) : {\{ 0 , 1 \}}^{N} \times C \to ℝ \qquad ( 5 )$$

However, the continuous relaxation method can still result in a complex loss landscape. In addition, in the continuous relaxation method, a solution of continuous optimization may be significantly different from a solution of original discrete optimization.

### Continuous Relaxation Annealing Method

In a continuous relaxation annealing method, a slack variable pe of the optimization problem is parametrized by a statistical model, and a loss function represented by the following expressions (6) and (7) is optimized.

$$\hat{r} ( {p}_{θ} ; ( C , λ , γ ) = \hat{E (} {p}_{θ} ( C ) ; C , λ ) + γ S ( {p}_{θ} ( C ) ) , S ( {p}_{θ} ( C ) ) = γ {\sum }_{i = 1}^{N} ( 1 - {( 2 {p}_{θ , i} - 1 )}^{a} ) \qquad ( 6 )$$

$$α ∈ \{ 2 n + 1 \vert n ∈ ℕ \} \qquad ( 7 )$$

In this case, when a coefficient γ is negative, the slack variable pe tends to take a half-integral ½ value. On the other hand, when the coefficient γ is positive, the slack variable pe tends to take a binary {0, 1} value.

In the continuous relaxation annealing method, by annealing the coefficient γ from a negative value to a positive value at the time of training, performance can be improved, and conversion from a continuous variable to a discrete variable can also be eliminated.

### Optimization Processing in Embodiment

In the optimization method described above, a solver needs to be executed for each weight parameter WP1 that weights the cost function, and it may take time to generate the Pareto optimum solution. The optimization processing performed by the machine training device 10 according to the embodiment generalizes the optimization method by the continuous relaxation annealing method described above to multi-objective optimization, and extends the method so that the Pareto front PF1 can be obtained by one time of training.

As represented by the following expression (8), the machine training device 10 formulates the slack variable pe as a function of λ, which is the weight parameter WP1, that is, as a response function regarding A.

$${p}_{θ} ( C ) \to {p}_{θ} ( C , λ ) \qquad ( 8 )$$

By using the slack variable p_{θ}(C, λ) as the response function of the expression (8) described above, the machine training device 10 receives inputs of C as the instance parameter IP1 indicating a characteristic of the multi-objective optimization problem OP1 and λ as the corresponding weight parameter WP1, and outputs a solution of relaxed single-objective optimization corresponding to λ.

At the time of training of the response function of the expression (8) described above, the machine training device 10 defines, as UniSim(λ), a uniform distribution on the simplex WS1 constructed by λ as the weight parameter WP1, and optimizes the following expression (9). Herein, the simplex WS1 is a set of solutions, and in a case of the multi-objective optimization problem OP1 including the M cost functions, the simplex WS1 is represented in a polyhedral shape having M vertices in (M−1) dimensions.

$${𝔼}_{λ ∼ UniSim ( λ )} \hat{r} ( {p}_{θ} ( C , λ ) ; C , λ , y ) \qquad ( 9 )$$

The machine training device 10 can train the response function of the expression (8) described above by two methods as follows. The following describes a case in which the slack variable p_{θ}(C, λ) is characterized by a Graph Neural Network (GNN) having an L-layer structure as the machine training model LM1 as represented by the following expression (10). The machine training model LM1 is not limited to the GNN, but may be a transformer, a Multi-Layer Perceptron (MLP), a Support-Vector Machine (SVM)), and the like.

$${p}_{θ} ( C , λ ) = GNN ( C , λ ; L ) . \qquad ( 10 )$$

### Node Embedding

The machine training device 10 performs node embedding as embedding based on A as the weight parameter WP1 (λ-based embedding) as training of the response function of the expression (10) described above. For example, the machine training device 10 extracts P points of λ according to UniSim(λ) of the expression (9) described above, and prepares λ as the weight parameter set WPS1 represented by the following expression (11). At this time, the machine training device 10 does not extract a corresponding solution from one point on the simplex defined by UniSim(λ), but extracts the corresponding solution set PS1 from all over the simplex WS1.

$$A = {\{ {λ}^{( μ )} \}}_{μ = 1}^{P} \qquad ( 11 )$$

The machine training device 10 also performs position embedding on the prepared A, uses converted embedding vectors as node features of the GNN, and minimizes the empirical loss regarding the P points.

### Linear Scaling

The machine training device 10 performs linear scaling for linearly scaling the weight parameter WP1 and the bias b1 using the response function of the expression (10) described above as training. For example, the machine training device 10 scales the weight parameter WP1 of the GNN in each layer as represented by the following expression (12). The machine training device 10 scales the bias b1 of the GNN in each layer as represented by the following expression (13).

$${W}^{( l )} ( λ ) = {σ}^{( l )} ( ( {W}_{res}^{( l )} ) \text{?} log ( λ ) + {b}_{res}^{( l )} ) {⊙}_{row} {W}_{base}^{( l )} \qquad ( 12 )$$

$${b}^{( l )} ( λ ) = {σ}^{( l )} ( ( {W}_{res}^{( l )} ) \text{?} log ( λ ) + {b}_{res}^{( l )} ) ⊙ {b}_{base}^{( l )} \qquad ( 13 )$$

$$\text{?} \text{indicates text missing or illegible when filed}$$

The machine training device 10 extracts P points of λ according to UniSim(λ) of the expression (9) described above, prepares λ as the weight parameter set WPS1 represented by the expression (11) described above, and minimizes the empirical loss regarding the P points similarly to the node embedding described above.

In this manner, the machine training device 10 does not need to execute a solver for each weight parameter WP1 that weights the cost function, so that a generation speed of the solution set PS1 of the multi-objective optimization problem OP1 can be improved.

### Application Example of Embodiment

As an application example 1 of the embodiment, the machine training device 10 can generate a Pareto optimum solution of the multi-objective optimization problem OP1 related to a transportation plan. For example, the machine training device 10 can generate a Pareto optimum solution of the multi-objective optimization problem OP1 including minimization of transportation cost (for example, fuel cost, time, and the like) as a cost function 1, minimization of emission volume of carbon dioxide (CO2) as a cost function 2, and minimization of delivery time as a cost function 3. That is, the machine training device 10 can provide the Pareto front PF1 to a logistics operator as the user U1 for simultaneously optimizing three objectives of suppressing transportation cost, reducing an environmental load (CO2 emission), and shortening delivery time to customers.

As an application example 2 of the embodiment, the machine training device 10 can generate a Pareto optimum solution of the multi-objective optimization problem OP1 related to a manufacturing step. For example, the machine training device 10 can generate a Pareto optimum solution of the multi-objective optimization problem OP1 including minimization of production cost as a cost function 1, minimization of production time as a cost function 2, and minimization of waste as a cost function 3. That is, the machine training device 10 can provide the Pareto front PF1 to a manufacturer as the user U1 for simultaneously optimizing three objectives of reducing production cost, shortening manufacturing time, and reducing waste.

### Functional Configuration

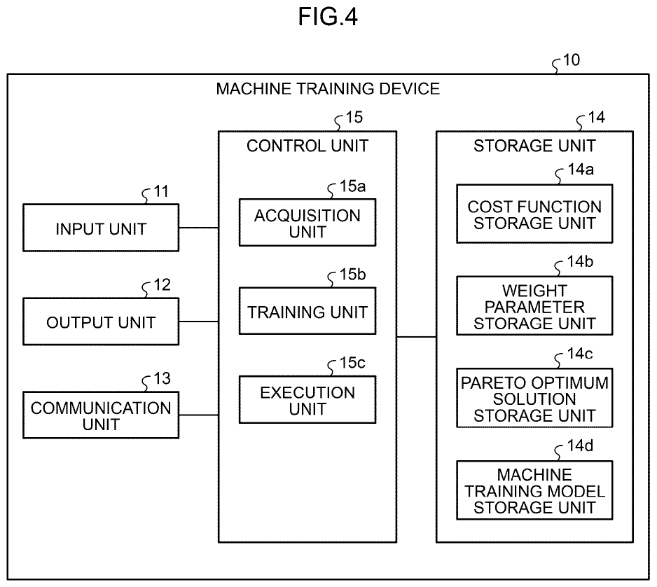

FIG. 4 is a block diagram of the machine training device 10 according to the embodiment. As illustrated in FIG. 4, the machine training device 10 includes an input unit 11, an output unit 12, a communication unit 13, a storage unit 14, and a control unit 15.

The input unit 11 is a processing unit that controls input of various kinds of information to the machine training device 10, and implemented by a mouse, a keyboard, or a touch panel, for example.

The output unit 12 is a processing unit that controls output of various kinds of information from the machine training device 10, and implemented by a display or a speaker, for example.

The communication unit 13 is a processing unit that controls communication with other devices, and implemented by a communication interface, for example.

The storage unit 14 is a processing unit that stores various kinds of data and various computer programs executed by the control unit 15, and is implemented by a memory or a hard disk, for example. For example, the storage unit 14 includes a cost function storage unit 14a, a weight parameter storage unit 14b, a Pareto optimum solution storage unit 14c, and a machine training model storage unit 14d.

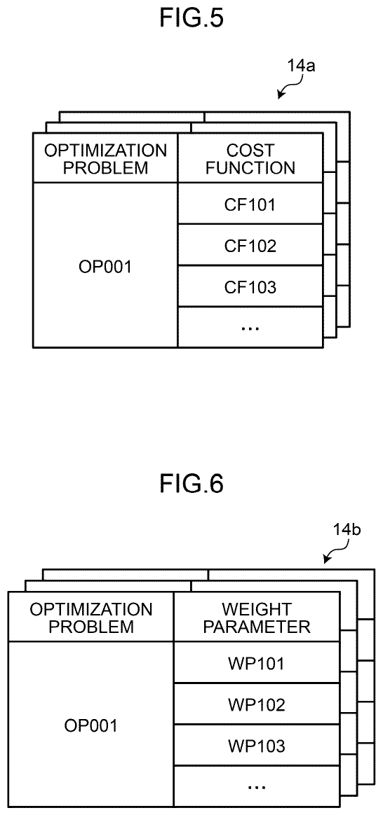

FIG. 5 is a diagram illustrating an example of the cost function storage unit 14a of the machine training device 10 according to the embodiment. The cost function storage unit 14a stores a plurality of the cost functions included in the multi-objective optimization problem OP1. The cost function storage unit 14a illustrated in FIG. 5 stores “CF101”, “CF102”, “CF103”, . . . as the cost functions included in the multi-objective optimization problem OP1 identified by “OP001”.

FIG. 6 is a diagram illustrating an example of the weight parameter storage unit 14b of the machine training device 10 according to the embodiment. The weight parameter storage unit 14b stores a plurality of the weight parameters WP1 that weight the cost functions included in the multi-objective optimization problem OP1. The weight parameter storage unit 14b illustrated in FIG. 6 stores “WP101”, “WP102”, “WP103”, . . . as the weight parameters WP1 that weight the cost functions included in the multi-objective optimization problem OP1 identified by “OP001”.

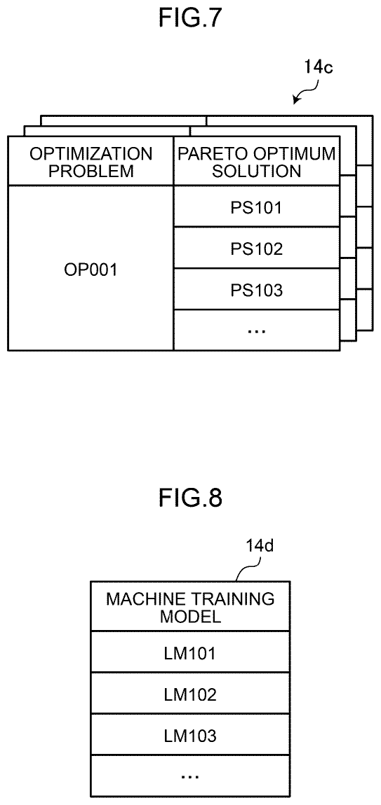

FIG. 7 is a diagram illustrating an example of the Pareto optimum solution storage unit 14c of the machine training device 10 according to the embodiment. The Pareto optimum solution storage unit 14c stores a Pareto optimum solution as the solution set PS1 of the multi-objective optimization problem OP1. The Pareto optimum solution storage unit 14c illustrated in FIG. 7 stores “PS101”, “PS102”, “PS103”, . . . as Pareto optimum solutions of the multi-objective optimization problem OP1 identified by “OP001”.

FIG. 8 is a diagram illustrating an example of the machine training model storage unit 14d of the machine training device 10 according to the embodiment. The machine training model storage unit 14d stores the trained machine training model LM1 used for solving the multi-objective optimization problem OP1. The machine training model storage unit 14d illustrated in FIG. 8 stores “LM101”, “LM102”, “LM103”, . . . as trained machine training models LM1 used for solving the multi-objective optimization problem OP1.

The control unit 15 is a processing unit that controls the machine training device 10, and implemented by a processor, for example. For example, the control unit 15 includes an acquisition unit 15a, a training unit 15b, and an execution unit 15c. The acquisition unit 15a, the training unit 15b, and the execution unit 15c are implemented by an electronic circuit included in a processor, a process executed by the processor, and the like.

The acquisition unit 15a acquires the multi-objective optimization problem OP1 including a plurality of the cost functions. For example, the acquisition unit 15a acquires, from the user U1, data of the multi-objective optimization problem OP1 aiming at simultaneously optimizing the M cost functions f1(x), f2(x), . . . , fM(x) with respect to arbitrary x∈X. Specifically, the acquisition unit 15a acquires data of the multi-objective optimization problem OP1 identified by “OP001”, which includes “CF101”, “CF102”, “CF103”, . . . as the cost functions, and stores the data in the cost function storage unit 14a.

The training unit 15b extracts the weight parameters WP1 based on the simplex WS1 constructed by points corresponding to the number of the weight parameters WP1 that weight the respective cost functions. Specifically, in a case where the number of the weight parameters WP1 for weighting the M cost functions included in the multi-objective optimization problem OP1 identified by “OP001” is M, the training unit 15b constructs the simplex WS1 represented as a polyhedral shape having M vertices in (M−1) dimensions, extracts “WP101”, “WP102”, “WP103”, . . . as the P weight parameters WP1 from arbitrary points on the simplex WS1, and stores them in the weight parameter storage unit 14b.

By inputting a mapping to the solution set PS1 corresponding to the weight parameters WP1, the training unit 15b trains the machine training model LM1 that outputs a solution set PS1* corresponding to the predetermined weight parameter WP1*. Specifically, the training unit 15b refers to “WP101”, “WP102”, “WP103”, . . . as the P weight parameters WP1 stored in the weight parameter storage unit 14b, and performs training by inputting the mapping to the solution set PS1 corresponding to the P weight parameters WP1 to “LM101” as the machine training model LM1 stored in the machine training model storage unit 14d.

The machine training model LM1 executes a response function as a slack variable, the response function regarding the instance parameter IP1 indicating a characteristic of the multi-objective optimization problem OP1 and the weight parameter WP1 corresponding to the instance parameter IP1. The machine training model LM1 also linearly scales the weight parameter WP1 and the bias b1 corresponding to the weight parameter WP1, as the response function. The machine training model LM1 also converts the weight parameter WP1 into an embedding vector as the response function, and minimizes an empirical loss.

The execution unit 15c inputs the predetermined weight parameter WP1* to the trained machine training model ML1, and generates the solution set PS1*. Specifically, the execution unit 15c inputs “WP101*” as the unknown weight parameter WP1* to “LM101” as the trained machine training model LM1 stored in the machine training model storage unit 14d, and acquires the Pareto optimum solution “PS101”, which is the output solution set PS1*. The execution unit 15c also generates the Pareto front PF1 including the solution set PS1*.

### Specific Processing Procedure

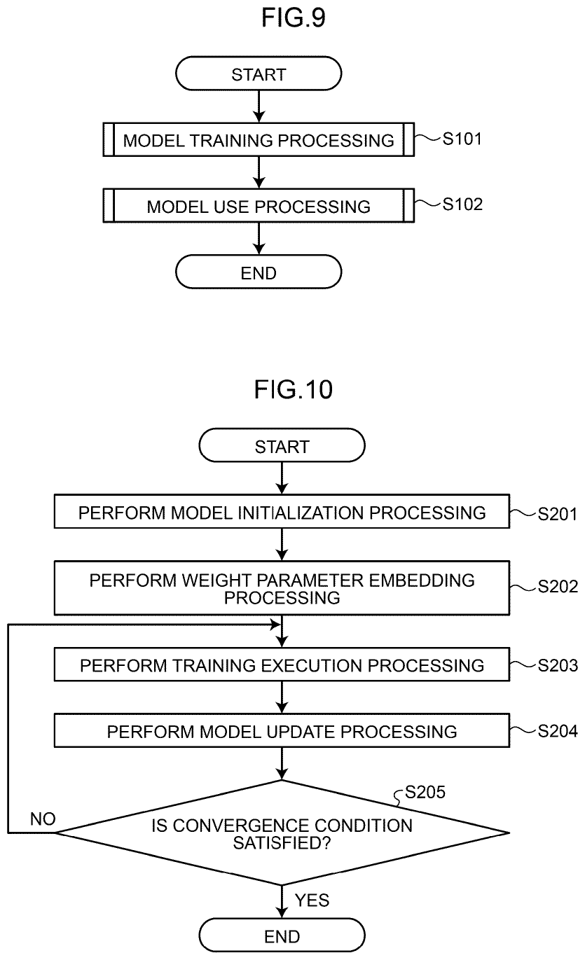

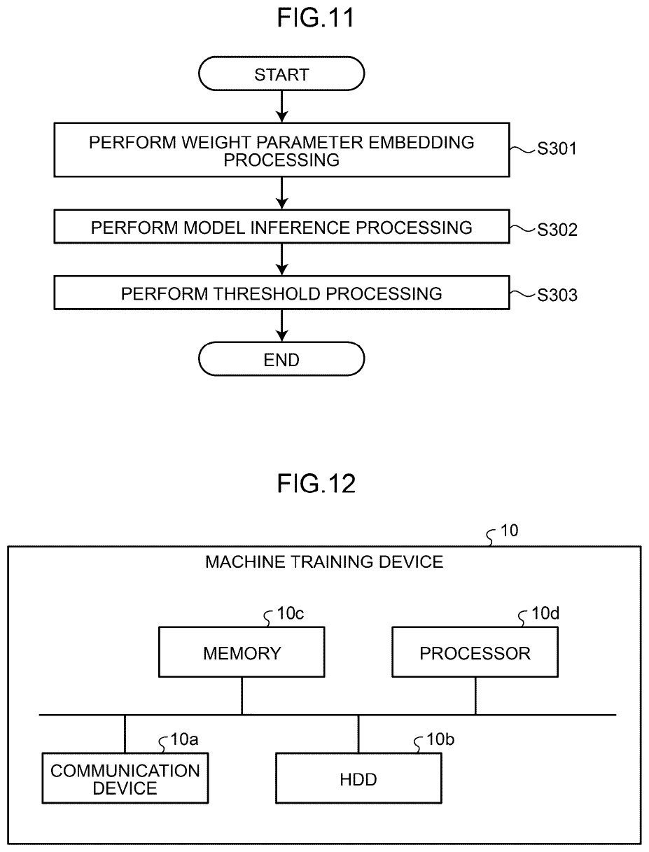

The following describes an example of a specific processing procedure performed by the machine training device 10 with reference to FIG. 9 to FIG. 11. FIG. 9 is a flowchart of the entire processing performed by the machine training device 10 according to the embodiment. FIG. 10 is a flowchart of model training processing performed by the machine training device 10 according to the embodiment. FIG. 11 is a flowchart of model use processing performed by the machine training device 10 according to the embodiment.

The following describes an example of the entire processing performed by the machine training device 10 according to the embodiment with reference to FIG. 9. The machine training device 10 performs the model training processing (Step S101). For example, by performing the processing at Steps S201 to S205 (described later), the machine training device 10 trains the machine training model LM1 that outputs the solution set PS1 of the multi-objective optimization problem OP1. The machine training device 10 also performs the model use processing (Step S102), and ends the processing. For example, by performing the processing at Steps S301 to S303 (described later), the machine training device 10 generates the Pareto front PF1 including the solution set PS1* corresponding to the arbitrary weight parameter WP1*.

The following describes an example of the model training processing performed by the machine training device 10 according to the embodiment with reference to FIG. 10. The machine training device 10 performs model initialization processing (Step S201). For example, the training unit 15b of the machine training device 10 sets model parameters of the machine training model LM1 to initial values determined in advance. The machine training device 10 performs weight parameter embedding processing (Step S202). For example, the training unit 15b of the machine training device 10 converts P points of the weight parameters WP1 extracted from the simplex WS1 of the multi-objective optimization problem OP1 into embedding vectors. The machine training device 10 performs training execution processing (Step S203). For example, the training unit 15b of the machine training device 10 uses the converted embedding vectors for node features of the machine training model LM1, and minimizes the empirical loss regarding the P weight parameters WP1. The machine training device 10 performs model update processing (Step S204). For example, the training unit 15b of the machine training device 10 calculates the gradient LG1 of the loss function, and updates the model parameters using the calculated gradient LG1 of the loss function. At this time, if a convergence condition is satisfied such that the processing is stopped when the loss function no longer decreases to some extent (Yes at step S205), the training unit 15b of the machine training device 10 ends the model training processing. On the other hand, if the convergence condition is not satisfied (No at Step S205), the training unit 15b of the machine training device 10 returns the process to Step S203.

The following describes an example of the model use processing performed by the machine training device 10 according to the embodiment with reference to FIG. 11. The machine training device 10 performs the weight parameter embedding processing (Step S301). For example, the execution unit 15c of the machine training device 10 converts the unknown weight parameter WP1* designated by the user U1 into an embedding vector. The machine training device 10 performs model inference processing (Step S302). For example, the execution unit 15c of the machine training device 10 inputs the converted embedding vector to the machine training model LM1, and acquires the solution set PS1* as an output inference result. The machine training device 10 performs threshold processing (Step S303), and ends the model use processing. For example, the execution unit 15c of the machine training device 10 binarizes each value output by the machine training model LM1 by providing a threshold, and converts a continuous value into a discrete value.

### Effects

The machine training device 10 acquires the multi-objective optimization problem OP1 including the cost functions, extracts the weight parameters WP1 based on the simplex WS1 constructed by points corresponding to the number of the weight parameters WP1 that weight the respective cost functions, and trains the machine training model LM1 that outputs the solution set PS1* corresponding to the predetermined weight parameter WP1* by inputting the mapping to the solution set PS1 corresponding to the weight parameters WP1. Due to this, the machine training device 10 can improve a generation speed of the solution set PS1 of the multi-objective optimization problem OP1.

The machine training model LM1 executes a response function as a slack variable, the response function regarding the instance parameter IP1 indicating a characteristic of the multi-objective optimization problem OP1 and the weight parameter WP1 corresponding to the instance parameter IP1. Due to this, the machine training device 10 can improve the generation speed of the solution set PS1 of the multi-objective optimization problem OP1 by generalizing the optimization method by the continuous relaxation annealing method to multi-objective optimization.

The machine training model LM1 linearly scales the weight parameter WP1 and the bias b1 corresponding to the weight parameter WP1, as the response function. Due to this, the machine training device 10 can improve the generation speed of the solution set PS1 of the multi-objective optimization problem OP1 by executing machine training to which linear scaling is applied.

The machine training model LM1 converts the weight parameter WP1 into an embedding vector as the response function, and minimizes the empirical loss. Due to this, the machine training device 10 can improve the generation speed of the solution set PS1 of the multi-objective optimization problem OP1 by executing machine training for embedding the weight parameters WP1 extracted from the simplex WS1.

The machine training device 10 inputs the predetermined weight parameter WP1* to the trained machine training model LM1, and generates the solution set PS1*. Due to this, the machine training device 10 can improve the generation speed of the solution set PS1 of the multi-objective optimization problem OP1 by generating the solution set PS1* corresponding to the unknown weight parameter WP1* by one time of training.

The machine training device 10 generates the Pareto front including the solution set PS1*. Due to this, the machine training device 10 can improve the generation speed of the solution set PS1 of the multi-objective optimization problem OP1 by generating the Pareto front PF1 corresponding to the unknown weight parameter WP1* by one time of training.

### System

The processing procedures, control procedures, specific names, and information including various kinds of data and parameters described herein and illustrated in the drawings may be optionally changed unless otherwise specifically noted.

In addition, specific forms of distribution and integration of constituent elements of each device are not limited to those illustrated. That is, all or part of the constituent elements may be functionally or physically distributed or integrated in arbitrary units according to various loads, usage conditions, and the like. Furthermore, all or any part of processing functions of each device may be implemented by a central processing unit (CPU) and a computer program analyzed and executed by the CPU, or may be implemented as hardware using wired logic.

Furthermore, all or any part of the processing functions executed by each device may be implemented by a CPU and a computer program analyzed and executed by the CPU, or may be implemented as hardware using wired logic.

### Hardware

FIG. 12 is a hardware configuration diagram of the machine training device. As illustrated in FIG. 12, the machine training device 10 includes a communication device 10a, a hard disk drive (HDD) 10b, a memory 10c, and a processor 10d. The components illustrated in FIG. 12 are connected to each other via a bus and the like.

The communication device 10a is a network interface card and the like, and communicates with other devices. The HDD 10b stores a DB and a computer program that activates the functions illustrated in FIG. 4.

The processor 10d activates a process for executing each function described above with reference to FIG. 4, for example, by reading, from the HDD 10b and the like, a computer program that executes processing similar to that of each processing unit illustrated in FIG. 4 and loading the computer program into the memory 10c. For example, the process described above executes a function similar to that of each processing unit included in the machine training device 10. Specifically, the processor 10d reads out, from the HDD 10b and the like, a computer program having functions similar to those of the acquisition unit 15a, the training unit 15b, the execution unit 15c, and the like. The processor 10d then executes a process for performing processing similar to that of the acquisition unit 15a, the training unit 15b, the execution unit 15c, and the like.

In this manner, the machine training device 10 operates as a machine training device that performs an information processing method by reading out and executing the computer program. The machine training device 10 can also implement functions similar to the functions in the embodiment described above by reading out the computer program from a recording medium by a medium reading device, and executing the read-out computer program. The computer program according to the embodiment is not limited to being executed by the machine training device 10. For example, the embodiment described above can be similarly applied to a case in which another computer or server executes the computer program, or a case in which they execute the computer program in cooperation with each other.

This computer program may be distributed via a network such as the Internet. This computer program may be recorded in a computer-readable recording medium such as a hard disk, a flexible disk (FD), a CD-ROM, a magneto-optical disk (MO), and a digital versatile disc (DVD), and may be executed by being read out from the recording medium by a computer.

According to the embodiment, it is possible to improve the generation speed of the solution set of the multi-objective optimization problem.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a machine training program that causes a computer to execute a process comprising:
acquiring a multi-objective optimization problem including a plurality of cost functions;
extracting a plurality of weight parameters based on a simplex constructed by points corresponding to a number of the weight parameters that weight the respective cost functions; and
training a machine training model that outputs a second solution set corresponding to a predetermined weight parameter by inputting a mapping to a first solution set corresponding to the weight parameters.

2. The non-transitory computer-readable recording medium according to claim 1, wherein the machine training model executes a response function as a slack variable, the response function regarding an instance parameter indicating a characteristic of the multi-objective optimization problem and a weight parameter corresponding to the instance parameter.

3. The non-transitory computer-readable recording medium according to claim 2, wherein the machine training model linearly scales the weight parameter and a bias corresponding to the weight parameter, as the response function.

4. The non-transitory computer-readable recording medium according to claim 2, wherein the machine training model converts the weight parameter into an embedding vector as the response function, and minimizes an empirical loss.

5. The non-transitory computer-readable recording medium according to claim 1, the process further including inputting the predetermined weight parameter to the machine training model that has been trained, and generating the second solution set.

6. The non-transitory computer-readable recording medium according to claim 5, wherein a Pareto front including the second solution set is generated.

7. A machine training device comprising:
a processor configured to:
acquire a multi-objective optimization problem including a plurality of cost functions;
extract a plurality of weight parameters based on a simplex constructed by points corresponding to a number of the weight parameters that weight the respective cost functions; and
train a machine training model that outputs a second solution set corresponding to a predetermined weight parameter by inputting a mapping to a first solution set corresponding to the weight parameters.

8. A machine training method comprising:
acquiring a multi-objective optimization problem including a plurality of cost functions;
extracting a plurality of weight parameters based on a simplex constructed by points corresponding to a number of the weight parameters that weight the respective cost functions; and
training a machine training model that outputs a second solution set corresponding to a predetermined weight parameter by inputting a mapping to a first solution set corresponding to the weight parameters, by a processor.
